(19) United States
(12) Patent Application Publication
(10) Pub. No.: US 2020/0192653 A1
(43) Pub. Date: Jun. 18, 2020

(54) System For Generating Installation Prompt According To Attribute Data And Installation Rule Of Each Material And Method Thereof

(71) Applicants: Inventec (Pudong) Technology Corporation, Shanghai (CN); Inventec Corporation, Taipei City (TW)

(72) Inventors: Zong-Lan Wang, Shanghai (CA); Xiao-Wei Yuan, Shanghai (CN)

(21) Appl. No.: 16/228,443

(22) Filed: Dec. 20, 2018

(30) Foreign Application Priority Data
Dec. 13, 2018 (CN) 201811528529.5

(51) Int. Cl. G06F 8/61

(52) U.S. Cl. CPC G06F 8/61

(57) ABSTRACT

A system for generating an installation prompt according to attribute data and an installation rule of each material and a method thereof are provided. By generating configuration location data of each material in a bill of materials according to the attribute data and the installation rule of each material, defining template data of each material according to the attribute data of each material, and then generating the installation prompt of each material in accordance with the configuration location data and the template data, the system and the method can automatically set the configuration location data of each material, and can achieve the technical effect of reducing operator workload and improving installation accuracy.

### BACKGROUND OF THE INVENTION

### 1. Field of the Invention

The present invention relates to a system for prompting an installation location of a material and a method thereof. In particular, the invention pertains to a system for generating an installation prompt according to attribute data and an installation rule of each material and a method thereof.

### 2. Description of the Related Art

At present, with regard to the installation operation of the computing device, it mostly defines a corresponding installation rule for each computing device. The operator completes the installation of each material in the bill of materials (BOM) according to the defined installation rules and installation experience. However, such an installation method often requires the operator with sufficient experience, and it is necessary to carefully confirm the specification and the installation rule of each material, otherwise it is easy to happen that the material does not meet the installation rule thereof or is installed in an incorrect location.

In order to solve such a problem, there is also an auxiliary software that gives an installation prompt during the process of installing materials by an operator. When installing the material, the operator can scan the material number of the material to be installed, and the auxiliary software can read the location information of the material according to the scanned material number, and display the read location information, so as to give the operator a corresponding installation prompt. As a result, the auxiliary software can provide direct and effective assistance when the operator installs the material.

However, in fact, before the operator installs the material, it is necessary to set the location information of each material of the BOM in the auxiliary software. Otherwise, the auxiliary software cannot give the installation prompt when the operator installs the material. Therefore, it still needs to set the location information of each material in the above-mentioned auxiliary software after the installation rule is carefully confirmed by an experienced operator. Once the quantity of material of the BOM is very large, it takes a lot of time to set the location information of the materials.

In summary, it can be seen that there are problems in the prior art that the auxiliary software for material installation is required to set the location information of the materials. Therefore, it is necessary to propose an improved technical solution to solve this problem.

### SUMMARY OF THE INVENTION

In view of the prior art, there is a problem that the auxiliary software for material installation is required to set the location information of the materials, and the present invention discloses a system for generating an installation prompt according to attribute data and an installation rule of each material and a method thereof.

The system for generating the installation prompt according to the attribute data and the installation rule of each material disclosed in the present invention comprises: a data acquisition module, configured to establish the attribute data of a plurality of the materials and the installation rule of each of the plurality of the materials; a list definition module, configured to a BOM comprising at least one of the plurality of the materials; a location determining module, configured to generate a configuration location data of the at least one of the plurality of the materials according to the attribute data of the at least one of the plurality of the materials and the installation rule of the at least one of the plurality of the materials; a template definition module, configured to define template data of the at least one of the plurality of the materials according to the attribute data of the at least one of the plurality of the materials; and an installation prompt module, configured to generate the installation prompt of the at least one of the plurality of the materials according to the configuration location data and the template data.

The method for generating the installation prompt according to the attribute data and the installation rule of each material disclosed in the present invention comprises the steps of: establishing the attribute data of a plurality of the materials; establishing the installation rule of each of the plurality of the materials; generating a BOM comprising at least one of the plurality of the materials; generating a configuration location data of the at least one of the plurality of the materials according to the attribute data of the at least one of the plurality of the materials and the installation rule of the at least one of the plurality of the materials; defining template data of the at least one of the plurality of the materials according to the attribute data of the at least one of the plurality of the materials; and generating the installation prompt of the at least one of the plurality of the materials according to the configuration location data and the template data.

The system and method disclosed by the present invention are as above, and the difference from the prior art is that generating configuration location data of each material in a bill of materials according to the attribute data and the installation rule of each material, defining template data of each material according to the attribute data of each material, and then generating the installation prompt of each material in accordance with the configuration location data and the template data. Above-mentioned technical means can be used to solve the problems of the prior art, and to achieve the technical effect of reducing operator workload and improving installation accuracy.

### BRIEF DESCRIPTION OF THE DRAWINGS

The structure, operating principle and effects of the present invention will be described in detail by way of various embodiments which are illustrated in the accompanying drawings.

FIG. 1 is a system architecture diagram of a system for generating an installation prompt according to attribute data and an installation rule of each material according to the present invention.

FIG. 2A is a flow chart of a method for generating an installation prompt according to attribute data and an installation rule of each material according to the present invention.

FIG. 2B is a flow chart of an additional method for generating an installation prompt according to attribute data and an installation rule of each material according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

As used herein, the term “or” includes any and all combinations of one or more of the associated listed items. It will be understood that when an element is referred to as being “connected to” another element, it can be connected to the other element, or intervening elements may be present. In contrast, when an element is referred to as being “directly connected to” another element, there are no intervening elements present.

In addition, unless explicitly described to the contrary, the word “comprise” and variations such as “comprises” or “comprising”, will be understood to imply the inclusion of stated elements but not the exclusion of any other elements.

The present invention is applied to a computing device, which can generate configuration location data of a material installed in a target device and corresponding template data, and can generate an installation prompt of each material in the target device according to the configuration location data and the template data to allow the operator to install each material on the target device based on the installation prompt.

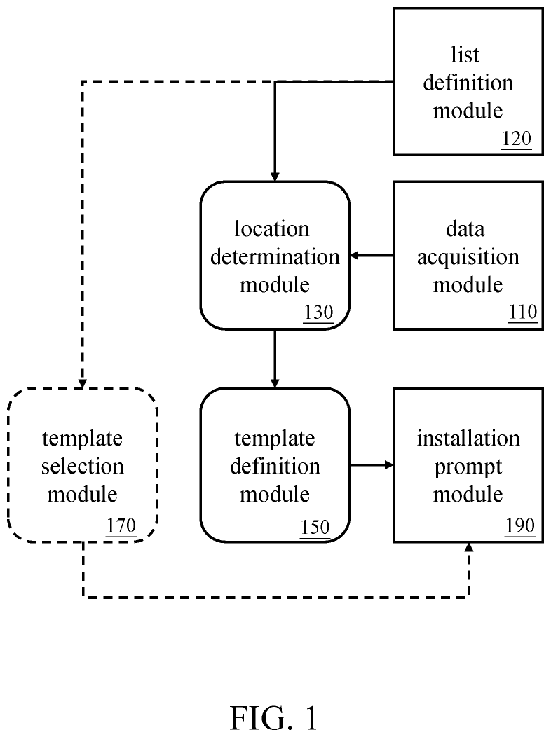

The operation of the system of the present invention will be described with reference to FIG. 1, and FIG. 1 is a system architecture diagram of a system for generating an installation prompt according to attribute data and an installation rule of each material according to the present invention. As shown in FIG. 1, the system of the present invention comprises a data acquisition module 110, a list definition module 120, a location determination module 130, a template definition module 150, an installation prompt module 190, and a template module 170 that can be attached.

The data acquisition module 110 is responsible for establishing attribute data of a plurality of materials. In the present invention, the attribute data of each material is data that can be used to describe the material, including but not limited to a material number, location information, shape information, capacity, a type, a connection interface, a data access speed, a data delivery speed, and a rotation speed. The material number is usually unique, which is used to identify the corresponding material, and can be arbitrarily arranged by any number of characters, letters, numbers and symbols. The location information can record where the material is installed to all locations in the target device. The shape information is used to indicate the size or shape of the material, but the invention is not limited thereto. The type is used to indicate the type of the material, such as a storage media, a motherboard, an expansion card, a fan, a battery, a backboard, and the like.

The data acquisition module 110 is also responsible for establishing the installation rule of each material. In the present invention, the installation rule of each material may indicate the slot information of the slot to which the material can be connected in the case where the target device has various different components, and the priority of selecting the connection, but the invention is not limited thereto.

The data acquisition module 110 can provide for inputting the attribute information of each material and/or the installation rule of each material through the input devices of the computing device of the present invention, such as a keyboard, a mouse, a touchpad, and the like, but the invention is not limited thereto. The data acquisition module 110 can provide a corresponding input interface to provide for inputting attribute data of each material and/or an installation rule of each material. The data acquisition module 110 can also provide for selecting or uploading one or more files to load the attribute data of each material and/or the installation rule of each material contained in the selected or uploaded file(s).

The data acquisition module 110 may also convert the format of the attribute data of each material and/or the installation rule of each material input or loaded by the file(s) into a predetermined format and store it. For example, the data acquisition module 110 may store the attribute data of each material and/or the installation rule of each material in different data tables of the data base, or use one or more files to store the attribute data of each material and/or installation rule of each material.

The list definition module 120 is responsible for generating a BOM. The BOM generated by the list definition module 120 comprises the material number, quantity, a type, and the like of each material to be installed in the target device, but the invention is not limited thereto.

Similar to the data acquisition module 110, the list definition module 120 can provide for inputting an BOM through the input devices of the computing device of the present invention, but the invention is not limited thereto. The list definition module 120 can provide a corresponding input interface to provide for inputting a BOM, or can provide for selecting or uploading a file containing the BOM.

The location determination module 130 is responsible for generating the configuration location data of each material according to the attribute data and the installation rule of each material in the BOM generated by the list definition module 120. The configuration location data generated by the location determination module 130 may indicate where the selected material is installed in the target device.

In more detail, the location determination module 130 can read the material numbers of all the materials in the BOM, and read out the attribute data and the installation rule of the material corresponding to the material number from the attribute data and the installation rules of the materials established by the data acquisition module 110 one by one, and can generate the configuration location data of the material corresponding to the material number, which is read out, according to the attribute data and the installation rule of the material, which are read out. For example, when the material is a PCIE card, the location determination module 130 may first determine where the material is installed in the area where the PCIE card is connected (for example, on the motherboard, or on the first expansion card or the second expansion card that can be connected to the motherboard) according to the installation rule, and then determine the slot in which the material is installed in the determined area according to the transmission speed (such as X8 or X16) recorded in the attribute data of the material, so that the configuration location data of the material can be generated.

The template definition module 150 is responsible for defining template data comprising the material number in the BOM generated by the list definition module 120 according to the attribute data of the material obtained by the data acquisition module 110. Since the template data comprises the material number of the material, the template data also corresponds to the material indicated by the material number.

The template data defined by the template definition module 150 comprises the identification data, the material number of the corresponding material, the corresponding base map, and all the locations where the corresponding material can be inserted on the target device. The identification data of the template data may be arranged by a predetermined rule by one or more attribute data of the corresponding material. For example, according to the number of slots of the material, the shape information of the material, the location information of the material, and the type of the material, and the like, the identification data of the template data is arranged.

In some embodiments, the template definition module 150 may add template data of one or more other materials in all materials, whose attribute data are established by the data acquisition module 110, to the template data of the material included in the BOM generated by the list definition module 120. That is to say, the template data of the material in the BOM may comprise identification data of template data of the other materials.

The template selection module 170 may select template data comprising the material number in the BOM generated by the list definition module 120 from all the template data defined by the template definition module 150. In more detail, the template selection module 170 can read the attribute data corresponding to the material number included in the BOM from the attribute data established by the data acquisition module 110, and search for template data corresponding with the identification data in each template data defined by the template definition module 150 according to the read attribute data.

The installation prompt module 190 is responsible for generating an installation prompt of the material corresponding to the template data defined by the template definition module 150 according to the configuration location data generated by the location determination module 130. In some embodiments, the template data corresponding to the installation prompt generated by the installation prompt module 190 is selected by the template selection module 170. The installation prompt generated by the installation prompt module 190 can graphically indicate the position of the material, which corresponds to the template data, mounted on the target device.

The installation prompt module 190 can load the base map in the template data defined by the template definition module 150 according to the configuration location data generated by the location determination module 130 when outputting the generated installation prompt to make the installation prompt output comprise the loaded base map.

The installation prompt module 190 can also output the generated installation prompt by executing the output devices of the computing device of the present invention. For example, the installation prompt module 190 can display the graphical interface of the computing device through the display or touch screen of the computing device, and indicate the installation location of the material in the graphical interface of the computing device; or the installation prompt module 190 can generate the printing data comprising the installation prompt, and print the installation prompt through the printer or the multifunction printer connected to the computing device (that is, the installation prompt module 190 can print the graphical interface of the computing device and the installation location of the material in the graphical interface of the computing device). However, the invention is not limited thereto.

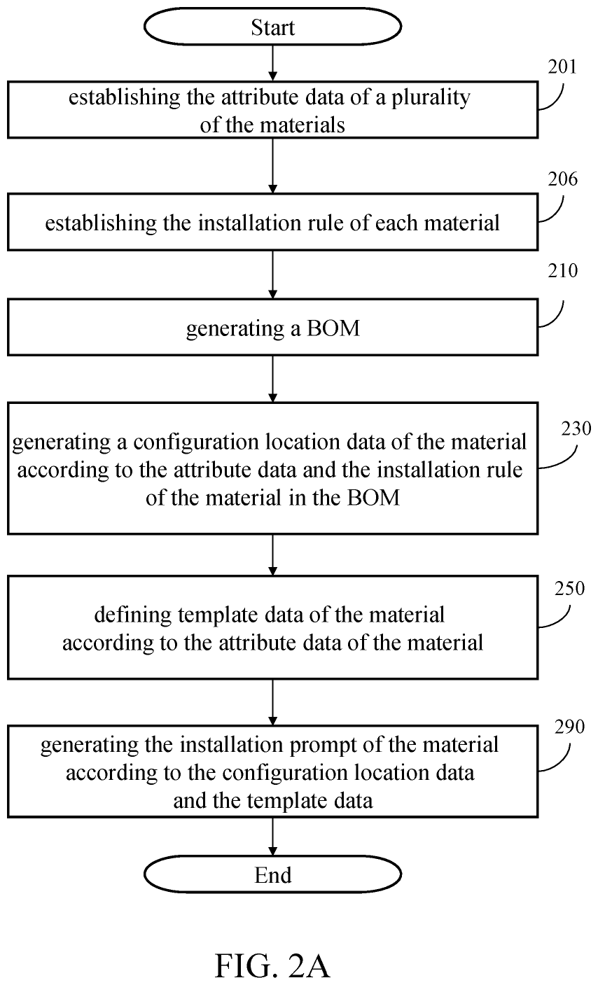

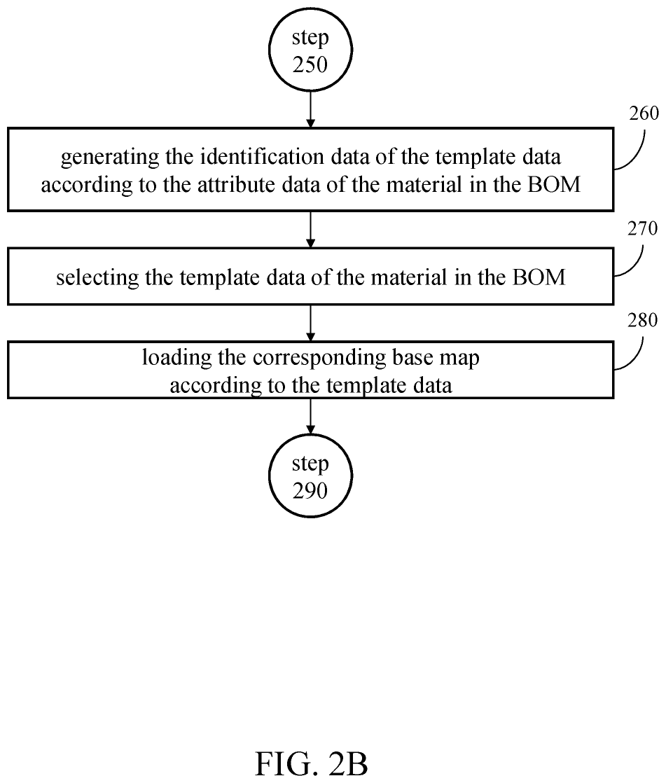

Next, an operational system and method of the present invention will be described with reference to an embodiment. Please refer to the FIG. 2A, which is a flow chart of a method for generating an installation prompt according to attribute data and an installation rule of each material according to the present invention.

First, the data acquisition module 110 may establish the attribute data and the installation rule of each material (steps 201, 206). In this embodiment, it is assumed that the data acquisition module 110 can provide for uploading the file in a predetermined format, and can convert the content of the uploaded file into the attribute data and the installation rule of the material. For example; the file comprises description information of the material such as a hard disk, a hard disk rack and a PC IF device, and after converting the content of the file, the data acquisition module 110 can obtain the attribute data of the hard disk comprising the material number, the media type; the transmission interface, the storage capacity, the rotation speed, the shape information, etc., and the installation rule of the hard disk comprising the smaller the storage capacity, the higher the priority is to install, and the lower the rotation speed, the higher the priority is to install, etc.; the attribute data of the hard disk rack comprising the material number; location information, the number of hard disk installations, the direction information, etc.; the attribute data of the PCIE device comprising the material number, the type, the transmission speed, the location information, etc., and the installation rule of the PCIE device comprising installing in the order of the slot number when there is a single CPU; installing in the order of the slot number when there are two CPUs and the number of slots is three; the slot number 4 or 5 is preferred for installation when there are two CPUs and the number of slots is five, etc.

After the data acquisition module 110 establishes the attribute data and the installation rule of each material (steps 201, 206), the list definition module 120 can generate a BONI required by the target device (step 210). In this embodiment, it is assumed that the material number of the hard disk is included in the BOM.

After the list definition module 120 generates the BOM required by the target device (step 210), the location determination module 130 can generate the configuration location data of each material in the BOM according to the attribute data and the installation rule of each material in the BOM generated by the list definition module 120 (step 230). In this embodiment, it is assumed that the location determination module 130 can read out the material number of the hard disk from the BOM, and then the location determination module 130 can the attribute data and the installation rule of the hard disk from the attribute data and the installation rule of each material established by the data acquisition module 110, and generate the configuration location data of the hard disk according to the attribute data and the installation rule of the hard disk, which are read out.

After the location determination module 130 generates the configuration location data of each material in the BOM, the template definition module 150 may define template data of each material indicated by each material number in the BOM according to the attribute data of each material established by the data acquisition module 110 (step 250). In this embodiment, the template data of the hard disk is defined.

After the template definition module 150 defines the template data of each material indicated by each material number in the BOM (step 250), the installation prompt module 190 can generate the installation prompt of each material corresponding to the template data defined by the template definition module 150 according to the configuration location data generated by the location determination module 130 (step 290), and the installation prompt is displayed. In this embodiment, the operator can input the identification data of the hard disk by scanning the code, and the installation prompt module 190 can obtain the configuration location data of the hard disk after obtaining the identification data of the input hard disk, and generate the installation prompt of the hard disk according to the configuration location data of the hard disk and the template data of the hard disk, and then display the installation prompt of the hard disk through the display.

In this way, the operator can install each material indicated in the BOM one by one on the target device according to each installation prompt generated by the present invention.

In the above embodiment, it can also be shown in the flow of FIG. 2B. When the template definition module 150 defines template data of each material indicated by each material number in the BOM according to the attribute data of each material established by the data acquisition module 110 (step 250), the template definition module 150 can read the attribute of each material indicated by the BOM generated by the list definition module 120 from the attribute data of each material established by the data acquisition module 110, and generate the identification data of the template data defined by the template definition module 150 according to the attribute data of the read material (step 260). It is assumed that the identification data of the template data is also used as the name of the template data.

Next, when the template selection module 170 selects the template data of the material indicated in the BOM according to the BOM generated by the list definition module 120 (step 270), the installation prompt module 190 can generate an installation prompt for the material corresponding to the template data defined by the template definition module 150 according to the configuration location data generated by the location determination module 130 (step 290). The installation prompt module 190 can also load the base map recorded in the template data defined by the template definition module 150 when generating the installation prompt (step 280). In this way, when the installation prompt module 190 displays the installation prompt, the base map can be displayed together, so that the operator can know more about the installation location of the material corresponding to the template data.

In summary, it can be seen that the difference between the present invention and the prior art is that generating configuration location data of each material in a bill of materials according to the attribute data and the installation nile of each material, defining template data of each material according to the attribute data of each material, and then generating the installation prompt of each material in accordance with the configuration location data and the template data. Above-mentioned technical means can be used to solve the problem in the prior art that the auxiliary software for material installation is required to set the location information of the materials, thereby achieving the technical effect of reducing operator workload and improving installation accuracy.

Furthermore, the method for generating the installation prompt according to the attribute data and the installation rule of each material of the present invention may be implemented by hardware, software or a combination thereof, and may be implemented by centralized computer system or different devices distributed in interconnected computer systems.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method for generating an installation prompt according to attribute data and an installation rule of each material, the method comprising following steps:
establishing the attribute data of a plurality of the materials;
establishing the installation rule of each of the plurality of the materials;
generating a bill of materials (BOM) comprising at least one of the plurality of the materials;
generating a configuration location data of the at least one of the plurality of the materials according to the attribute data of the at least one of the plurality of the materials and the installation rule of the at least one of the plurality of the materials;
defining template data of the at least one of the plurality of the materials according to the attribute data of the at least one of the plurality of the materials; and
generating the installation prompt of the at least one of the plurality of the materials according to the configuration location data and the template data.

2. The method for generating the installation prompt according to the attribute data and the installation rule of each material according to claim 1, wherein the step of generating the installation prompt of the at least one of the plurality of the materials according to the configuration location data and the template data further comprises the step of loading a corresponding base map according to the template data.

3. The method for generating the installation prompt according to the attribute data and the installation rule of each material according to claim 1, wherein before the step of generating the installation prompt of the at least one of the plurality of the materials according to the configuration location data and the template data, the method further comprises the step of selecting the template data of the at least one of the plurality of the materials according to the BOM.

4. The method for generating the installation prompt according to the attribute data and the installation rule of each material according to claim 1, wherein the step of defining the template data of the at least one of the plurality of the materials according to the attribute data of the at least one of the plurality of the materials further comprises the step of generating identification data of the template data according to the attribute data of the at least one of the plurality of the materials.

5. The method for generating the installation prompt according to the attribute data and the installation rule of each material according to claim 1; wherein the step of defining the template data of the at least one of the plurality of the materials according to the attribute data of the at least one of the plurality of the materials further comprises the step of adding identification data of template data of at least one of the other materials to the template data of the at least one of the plurality of the materials.

6. A system for generating an installation prompt according to attribute data and an installation rule of each material, the system comprising:
a data acquisition module, configured to establish the attribute data of a plurality of the materials and the installation rule of each of the plurality of the materials;
a list definition module, configured to a BOM comprising at least one of the plurality of the materials;
a location determining module; configured to generate a configuration location data of the at least one of the plurality of the materials according to the attribute data of the at least one of the plurality of the materials and the installation nile of the at least one of the plurality of the materials;
a template definition module, configured to define template data of the at least one of the plurality of the materials according to the attribute data of the at least one of the plurality of the materials; and
an installation prompt module; configured to generate the installation prompt of the at least one of the plurality of the materials according to the configuration location data and the template data.

7. The system for generating the installation prompt according to the attribute data and the installation rule of each material according to claim 6, wherein the installation prompt module is further configured to load a corresponding base map according to the template data.

8. The system for generating the installation prompt according to the attribute data and the installation rule of each material according to claim 6, wherein the system further comprises a template selection module, configured to select the template data of the at least one of the plurality of the materials according to the BOM.

9. The system for generating the installation prompt according to the attribute data and the installation rule of each material according to claim 6, wherein the template definition module is further configured to generate identification data of the template data according to the attribute data of the at least one of the plurality of the materials.

10. The system for generating the installation prompt according to the attribute data and the installation rule of each material according to claim 6, wherein the template definition module is further configured to add identification data of template data of at least one of the other materials to the template data of the at least one of the plurality of the materials.
